(19) United States
(12) Patent Application Publication
(10) Pub. No.: US 2015/0006065 A1
(43) Pub. Date: Jan. 1, 2015

(54) CONTROL DEVICE OF VEHICLE

(71) Applicants: Koji Yamamoto, Okazaki-shi (JP); Takayoshi Okuda, Nagoya-shi (JP); Hideaki Yaguchi, Toyota-shi (JP); Toshiya Hashimoto, Miyoshi-shi (JP)

(72) Inventors: Koji Yamamoto, Okazaki-shi (JP); Takayoshi Okuda, Nagoya-shi (JP); Hideaki Yaguchi, Toyota-shi (JP); Toshiya Hashimoto, Miyoshi-shi (JP)

(73) Assignee: TOYOTA JIDOSHA KABUSHIKI KAISHA, Toyota-shi, Aichi-ken (JP)

(21) Appl. No.: 14/370,626

(22) PCT Filed: Jan. 3, 2013
(86) PCT No.: PCT/IB2013/000002

§ 371 Date: Jul. 3, 2014

(30) Foreign Application Priority Data
Jan. 5, 2012 (JP) 2012-000766

(51) Int. Cl. F02D 29/02

(52) U.S. Cl. CPC F02D 29/02; F02D 2700/07
USPC 701/113

(57) ABSTRACT

An ECU starts an engine when an operation to deactivate the hybrid system has been performed during travel of the hybrid vehicle and then an operation to activate the hybrid system is performed before a hybrid vehicle stops.

### BACKGROUND OF THE INVENTION

1. Field of the Invention

The invention relates to a control device of a hybrid vehicle.

2. Description of Related Art

Control devices that are provided in hybrid vehicles equipped with an engine and a motor for travel are available (for instance, Japanese Patent Application Publication No. 2007-203835 (JP 2007-203835 A)).

JP 2007-203835 A discloses a hybrid vehicle that is provided with an engine, a first motor generator that functions mainly as a power generator, a planetary gear mechanism that splits motive power from the engine and transmits the motive power to drive wheels and a first motor generator, and a second motor generator that functions mainly as an electric motor. The hybrid vehicle can travel by virtue of the motive power of the engine and the motive power of the second motor generator, and can travel (EV travel) by virtue of the motive power alone of the second motor generator, while the engine is stopped.

In the hybrid vehicle, an activation operation of a hybrid system (vehicle system) is determined to have taken place in a case where a power switch is operated with a brake pedal in an operated state. The hybrid vehicle is brought to travel-enabled state (Ready-On state), without start of the engine, in a case where the hybrid vehicle is in an EV travel-enabled state. By contrast, the vehicle is brought to the Ready-On state, after start of the engine, in cases where, for instance, warm-up is required, or the residual capacity of a storage device is insufficient.

In the hybrid vehicle, the hybrid system is determined to have been deactivated in a case where a power switch has been operated while the hybrid system is activated.

Conceivably, the driver may activate the hybrid system before travel of the hybrid vehicle is discontinued (during coasting) in a case where the driver deactivates the hybrid system during travel of the hybrid vehicle.

In conventional hybrid vehicles, however, the driver does not readily notice that the activation operation has been received in a case where the EV travel state is brought about when the hybrid system is activated again.

### SUMMARY OF THE INVENTION

It is an object of the invention to provide a control device of a vehicle such that the driver can readily recognize that an activation operation of the vehicle system has been received, in a case where the vehicle system is activated after the vehicle system has been deactivated, during travel of the vehicle.

A first aspect of the invention relates to a control device of a vehicle, comprises an engine, an electric motor configured to drive the vehicle in a state where the engine is stopped, an operation unit configured to receive operations to activate and deactivate a vehicle system that controls travel of the vehicle; and a controller that controls the engine. The controller is configured so that, during travel of the vehicle, when the operation unit receives the operation to deactivate the vehicle system, and then the operation unit receives the operation to activate the vehicle system before the vehicle stops, the controller starts the engine.

In this control device, the driver can be readily made aware of the fact that the activation operation has been received, since start of the engine gives rise to sound and vibration.

In the control device of a vehicle of the first aspect of the invention, the controller may be configured so that, during travel of the vehicle, when the operation unit receives the operation to deactivate the vehicle system, and then the operation unit receives the operation to activate the vehicle system after at least part of the vehicle system has been deactivated and before the vehicle stops, the controller starts the engine.

In this control device, the driver can be readily made aware of the fact that the activation operation has been received, since start of the engine gives rise to sound and vibration, as a result of start of the engine even if the operation to activate the vehicle system has been performed, after at least part of the vehicle system has been deactivated.

In the control device of a vehicle of the first aspect of the invention, the abovementioned at least part of the vehicle system may include supply of fuel to the engine.

In this control device, the driver can be readily made aware of the fact that the operation to activate the vehicle system has been received, since start of the engine gives rise to sound and vibration, as a result of start of the engine when the operation to activate the vehicle system has been performed after the engine stops as a result of the vehicle system being deactivated.

In the control device of a vehicle of the first aspect of the invention, the controller may is configured so that, when the operation unit receives the operation to activate the vehicle system before the vehicle stops, the controller sets a start parameter used to start the engine to be a first value which differs from a second value of the start parameter used to start the engine at normal times, and a start mode of the engine varies in accordance with the value of the start parameter.

In this control device, the first start parameter differs in values from the second start parameter, so that, as a result, sound and vibration can be generated that are appropriate for making the driver aware of the fact that the operation to activate the vehicle system has been received.

In the control device of a vehicle of the first aspect of the invention, the controller may set the start parameter to be the first value in such a manner that a rotational speed of the engine is greater than in the case where the start parameter is set to the second value.

By virtue of this control device, sound and vibration upon start of the engine can be made more intense. Accordingly, the driver can be easily made aware of the fact that the operation to activate the vehicle system has been received.

In the control device of a vehicle of the first aspect of the invention, the controller may set the start parameter to be the first value in such a manner that motive power of the engine is smaller than in the case where the start parameter is set to the second value.

This control device prevents drops in drivability resulting from start of the engine, for instance in cases where engine start is not necessarily required in terms of demand of driving force.

In the control device of a vehicle of the first aspect of the invention, the vehicle may be configured so as to enable control of a proportion of motive power from the engine and motive power from the motor, out of motive power that is outputted to drive wheels; and the controller may set the proportion of motive power that is transmitted from the engine to the drive wheels to be smaller in a case where the engine is started when the operations unit receives the operation to activate the vehicle system during travel of the vehicle, than in a case where the engine is started at normal times.

This control device allows curtailing drops in drivability that accompany start of the engine, for instance in cases where engine start is not necessarily required in terms of demand of driving force.

In the control device of a vehicle of the first aspect of the invention, the controller may be configured to discontinue supply of fuel to the engine, when the operation unit receives the operation to activate the vehicle system so as to start the engine before the vehicle stops and then a predetermined period of time elapses after the engine starts.

By virtue of this control device, consumption of fuel in the engine can be restricted while preventing the driver from mistakenly concluding that the engine is in a stall state.

In the control device of a vehicle of the first aspect of the invention, the controller may be configured to discontinue supply of fuel to the engine, when the operation unit receives the operation to activate the vehicle system so as to start the engine before the vehicle stops and then a shift operation is performed after the engine starts.

When a shift operation has been performed, the driver may in some instances have already noticed that the operation to activate the vehicle system has been received. Therefore, the control device makes it possible to avoid useless consumption of fuel in the engine once the driver has noticed that the operation to activate the vehicle system has been received.

A second aspect of the invention relates to a control device of a vehicle, comprises an engine, an electric motor configured to drive the vehicle in a state where the engine is stopped, an operation unit configured to receive operations to activate and deactivate a vehicle system that controls travel of the vehicle, and a controller that controls the engine. The controller is configured so that, during travel of the vehicle, when an occupant performs the operation to deactivate the vehicle system through the operation unit, and then the occupant performs the operation to activate the vehicle system through the operation unit before the vehicle stops, the controller starts the engine.

In this control device, the driver can be readily made aware of the fact that the operation to activate the vehicle system has been received, since start of the engine gives rise to sound and vibration.

A third aspect of the invention relates to a control device of a vehicle, comprises an engine, an electric motor configured to drive the vehicle in a state where the engine is stopped, an operation unit configured to receive operations to activate and deactivate a vehicle system that controls travel of the vehicle, and a controller that controls the engine. The controller is configured so that, during travel of the vehicle, when the controller receives a signal to deactivate the vehicle system from the operation unit and then the controller receives a signal to activate the vehicle system from the operation unit before the vehicle stops, the controller starts the engine.

In this control device, the driver can be readily made aware of the fact that the operation to activate the vehicle system has been received, since start of the engine gives rise to sound and vibration.

In the control device of the aspects of invention, the driver can be readily made aware of the fact that the operation to activate the vehicle system has been received when the vehicle system is activated after the vehicle system has been deactivated, during travel of the vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram illustrating a hybrid vehicle provided with an ECU according to an embodiment of the invention;

FIG. 2 is a schematic diagram illustrating a shift operation device in the hybrid vehicle illustrated in FIG. 1;

FIG. 3 is a block diagram illustrating an ECU of the hybrid vehicle illustrated in FIG. 1;

FIG. 4 is a flowchart for explaining an activation process of a hybrid system during travel of the hybrid vehicle illustrated in FIG. 1;

FIG. 5 is a flowchart for explaining control upon system activation during travel in step S4 of FIG. 4; and

FIG. 6 is a schematic configuration diagram illustrating a hybrid vehicle according to a variation of the embodiment.

### DETAILED DESCRIPTION OF EMBODIMENTS

Embodiments of the invention are explained next with reference to accompanying drawings. In the present embodiment an instance will be explained wherein the invention is used in the ECU of a hybrid vehicle of front-engine, front-wheel drive (FF) type.

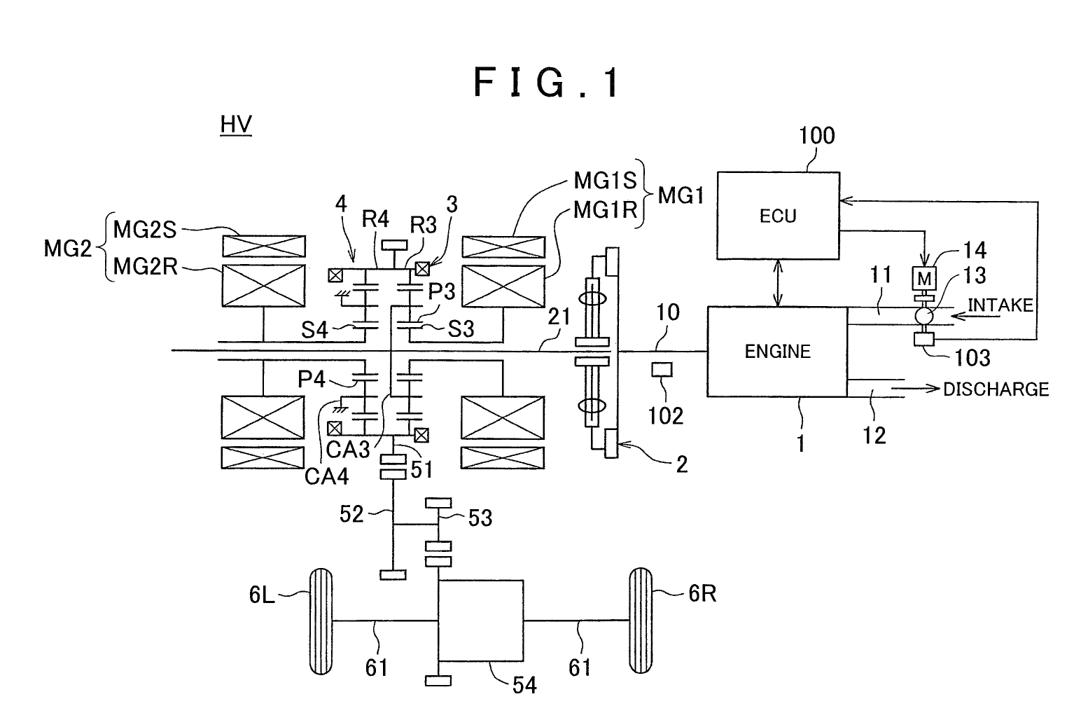

FIG. 1 is a schematic configuration diagram illustrating a hybrid vehicle according to the present embodiment. As illustrated in FIG. 1, a hybrid vehicle HV is provided with, for instance, an engine (internal combustion engine) 1, a first motor generator MG1, a second motor generator MG2, a motive power split mechanism 3, a reduction mechanism 4, a counter drive gear 51, a counter driven gear 52, a final gear 53, a differential device 54, front axles (drive shafts) 61, front wheels (drive wheels) 6L, 6R, and an electronic control unit (ECU) 100. The engine 1 generates a driving force for vehicle travel. The first motor generator MG1 functions mainly as a power generator. The second motor generator MG2 functions mainly as an electric motor. The second motor generator MG2 is an example of the “motor” of the invention, and the ECU 100 is an example of the “control device” of the invention.

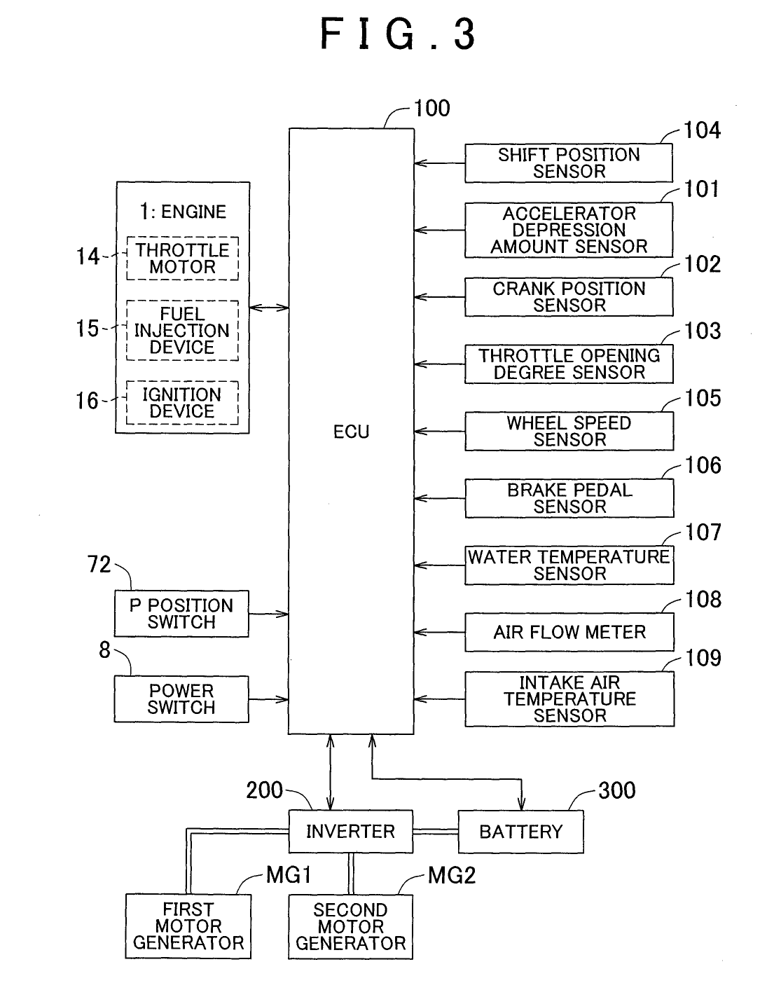

The ECU 100 is made up of, for instance, an HV (hybrid) ECU, an MGECU, an engine ECU, a battery ECU and so forth. These ECUs are connected so as to be capable of communicating with each other. The HVECU controls the hybrid vehicle HV in an integral manner. The MGECU controls the inverter 200 (FIG. 3). The engine ECU controls the engine 1. The battery ECU manages the state of a battery 300 (FIG. 3).

The various units of the engine 1, the motor generators MG1, MG2, the motive power split mechanism 3, the reduction mechanism 4, the ECU 100 and so forth are explained further on.

The engine 1 is a conventional motive power device (internal combustion engine) such as a gasoline engine, a diesel engine or the like, that outputs motive power resulting from combustion of a fuel. The engine 1 is configured in such a manner that it is possible to control driving states that include the throttle opening degree (intake air amount) of a throttle valve 13 that is provided in an intake passage 11, as well as a fuel injection amount, ignition timing, and so forth. Exhaust gas after combustion passes through an exhaust passage 12 and is purified by an oxidation catalyst, not shown. The exhaust gas is thereafter discharged into outside air.

To control the throttle valve 13 of the engine 1, for instance, electronic throttle control is employed so as to achieve an optimal intake air amount (target intake air amount) in accordance with the state of the engine 1, in terms of, for instance, engine revolutions and depression amount of the accelerator pedal (accelerator depression amount) by the driver. In such electronic throttle control there is detected an actual throttle opening degree of the throttle valve 13 by way of a throttle opening degree sensor 103. A throttle motor 14 of the throttle valve 13 is feedback-controlled in such a manner that the actual throttle opening degree matches the throttle opening degree (target throttle opening degree) for which the abovementioned target intake air amount is obtained.

The output of the engine 1 is transmitted to an input shaft 21, via a crankshaft 10 and a damper 2. The damper 2, which is for instance a coil spring-type transaxle damper, absorbs torque fluctuations of the engine 1.

The first motor generator MG1 is an AC synchronous power generator that is provided with a rotor MG1R having a permanent magnet that is supported so as to rotate freely with respect to the input shaft 21, and a stator MG1S around which three-phase winding is wound. The first motor generator MG1 functions as a power generator and as an electric motor. Similarly to the first motor generator MG1, the second motor generator MG2 is an AC synchronous power generator that is provided with a rotor MG2R having a permanent magnet that is supported so as to rotate freely with respect to the input shaft 21, and a stator MG2S around which three-phase winding is wound. The second motor generator MG2 as well functions as an electric motor and as a power generator.

As FIG. 3 shows, the first motor generator MG1 and the second motor generator MG2 are connected to the battery (storage device) 300 via the inverter 200. The inverter 200 is controlled by the ECU 100. Regeneration or powering (assist) in the motor generators MG1, MG2 is set through control of the inverter 200. The battery 300 is charged with regenerative electric power via the inverter 200. Electric power for driving the motor generators MG1, MG2 is supplied from the battery 300 via the inverter 200.

As illustrated in FIG. 1, the motive power split mechanism 3 is made up of a planetary gear mechanism having a sun gear S3, pinion gears P3, a ring gear R3, and a planetary carrier CA3. The sun gear S3 is an external gear that rotates at the center of a plurality of gear elements. The pinion gears P3 are external gears that circumscribe the sun gear S3 and that, while rotating, revolve along the periphery of the sun gear S3. The ring gear R3 is an internal gear, having a hollow annular shape, such that the pinion gears P3 mesh with the ring gear R3. The planetary carrier CA3 supports the pinion gears P3 and rotates as a result of the revolving of the pinion gears P3. The planetary carrier CA3 is integrally connected, in a rotatable state, to the input shaft 21 on the engine 1 side. The sun gear S3 is integrally connected, in a rotatable state, to the rotor MG1R of the first motor generator MG1.

The motive power split mechanism 3 transmits driving force from at least one from among the engine 1 and the second motor generator MG2, to the left and right drive wheels 6L, 6R, via the counter drive gear 51, the counter driven gear 52, the final gear 53, the differential device 54 and the drive shafts 61.

The reduction mechanism 4 is made up of a planetary gear mechanism that has a sun gear S4, a carrier (transaxle case) CA4, pinion gears P4 and a ring gear R4. The sun gear S4 is an external gear that rotates at the center of a plurality of gear elements. The pinion gears P4, which are rotatably supported on the carrier (transaxle case) CA4, are external gears that rotate while circumscribed on the sun gear S4. The ring gear R4 is an internal gear, having a hollow annular shape, such that the pinion gears P4 mesh with the ring gear R4. The ring gear R4 of the reduction mechanism 4, the ring gear R3 of the motive power split mechanism 3 and the counter drive gear 51 are integrated with each other. The sun gear S4 is integrally connected, in a rotatable state, to the rotor MG2R of the second motor generator MG2.

The reduction mechanism 4 reduces the driving force of the second motor generator MG2 according to an appropriate reduction ratio. The reduced driving force is transmitted to the left and right drive wheels 6L, 6R via the counter drive gear 51, the counter driven gear 52, the final gear 53, the differential device 54 and the drive shafts 61.

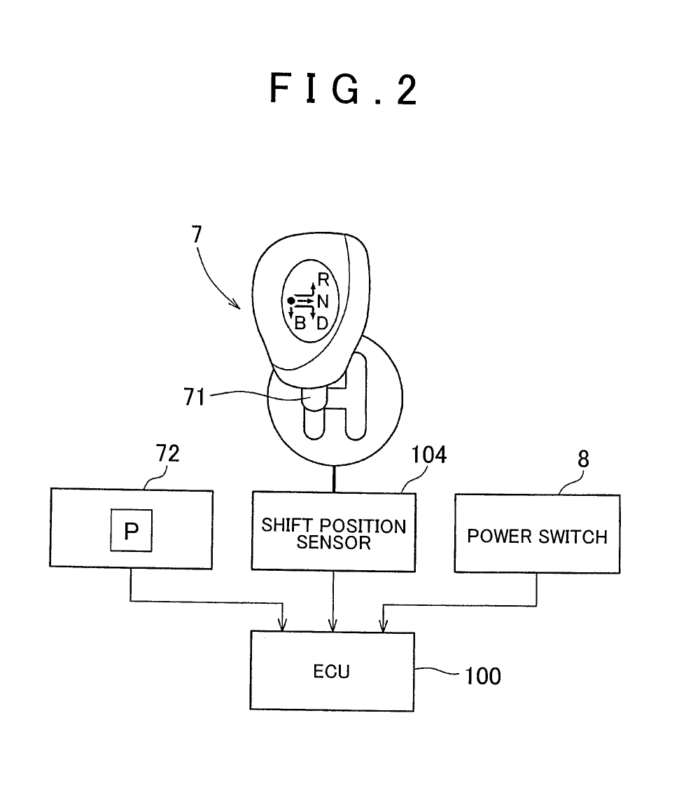

A shift operation device 7 (FIG. 2) is disposed in the vicinity of the driver's seat in the hybrid vehicle HV. As illustrated in FIG. 2, a shift lever 71 is provided, in a displaceable manner, in the shift operation device 7. A drive position (D position), a brake position (B position), a reverse position (R position) and neutral position (N position) are set in the shift operation device 7 of the present example. The drive position is used for forward travel. The brake position is used for forward travel wherein braking power (engine brake) is substantial at times where the accelerator is off. The reverse position is used for reverse travel. The neutral position is neutral. The driver can displace the shift lever 71 to a desired position. The various positions from among the D position, B position, R position and N position are detected by a shift position sensor 104. An output signal of the shift position sensor 104 is inputted to the ECU 100. A P position switch 72 for setting a parking position (P position) for parking is provided in the vicinity of the shift lever 71. When the driver operates the P position switch 72, a corresponding operation signal is outputted to the ECU 100.

A power switch 8 for activating and deactivating the hybrid system (vehicle system) is provided in the hybrid vehicle HV. The power switch 8 is, for instance, a rebound-type push switch. The power switch 8 is an example of the “operation unit” of the invention.

The hybrid system is herein a system that controls the travel of the hybrid vehicle HV by executing various control items that include, for instance, operation control of the engine 1, driving control of the motor generators MG1, MG2, and coordinated control of the engine 1 and the motor generators MG1, MG2. That is, the hybrid vehicle HV is configured so that it is possible to control the proportion of motive power from the engine 1 and motive power from the second motor generator MG2, in the motive power that is outputted to the drive shafts 61 (front wheels 6L, 6R).

When an occupant such as the driver operates the power switch 8, a signal corresponding to that operation is outputted to the ECU 100. The ECU 100 initiates activation and deactivation of the hybrid system on the basis of, for instance, the signal outputted by the power switch 8. That is, the power switch 8 is provided for the purpose of receiving the operation, by an occupant such as the driver, to activate or deactivate the hybrid system.

The ECU 100 of the hybrid vehicle HV, for instance, deactivates the hybrid system in a case where, with the hybrid system activated, the power switch 8 is operated (for instance, through short pressing) when the position switch 72 is in the P position during vehicle stop.

For instance, the ECU 100 activates the hybrid system in a case where the power switch 8 is operated (for instance, through short pressing) when the brake pedal is depressed while the hybrid vehicle HV is stopped. The operation that takes place when the power switch 8 is operated during travel of the hybrid vehicle HV will be explained in detail further on.

The ECU 100 is an electronic control device that executes the abovementioned hybrid system. The ECU 100 is provided with, for instance, a central processing unit (CPU), a read only memory (ROM), a random access memory (RAM), a backup RAM and the like.

The ROM has stored therein, for instance, various control programs, as well as maps for reference upon execution of the various control programs. The CPU executes arithmetic processing on the basis of the various control programs and maps stored in the ROM. The RAM is a memory that stores temporarily, for instance, computation results from the CPU, as well as data that is inputted by various sensors. The backup RAM is a non-volatile memory that stores, for instance, data that should be saved, for instance when the hybrid system is switched off.

As illustrated in FIG. 3, an accelerator depression amount sensor 101, a crank position sensor 102, a throttle opening degree sensor 103, a shift position sensor 104, the P position switch 72, a wheel speed sensor 105, a brake pedal sensor 106, a water temperature sensor 107, an air flow meter 108, an intake air temperature sensor 109, the power switch 8 and the like are connected to the ECU 100. Signals from the respective sensors are inputted to the ECU 100. The accelerator depression amount sensor 101 detects an accelerator depression amount that is the depression amount of the accelerator pedal. The crank position sensor 102 generates a pulse signal whenever the crankshaft 10 rotates by a predefined angle. The wheel speed sensor 105 detects the rotational speed of a wheel. The brake pedal sensor 106 detects a pedal force (brake pedal force) on the brake pedal. The water temperature sensor 107 detects an engine cooling water temperature. The air flow meter 108 detects an intake air amount. The intake air temperature sensor 109 detects an intake air temperature. An air-fuel ratio sensor, an O2 sensor, a current sensor that detects the charge and discharge current of the battery 300, a battery temperature sensor and so forth, not shown, are likewise connected to the ECU 100. Signals from these respective sensors are also inputted to the ECU 100.

The throttle motor 14 that drives the opening and closing of the throttle valve 13 of the engine 1, as well as a fuel injection device (injector) 15, an ignition device 16 and the like, are also connected to the ECU 100.

The ECU 100 executes various control items on the engine 1, for instance, throttle opening degree control (intake air amount control), fuel injection amount control and ignition timing control, on the basis of the output signals of the abovementioned various sensors.

In order to manage the battery 300, the ECU 100 computes, for instance, a state of charge (SOC) of the battery 300, as well as an input limit Win and output limit Wout of the battery 300, on the basis of, for instance, a cumulative value of charge and discharge current detected by the abovementioned current sensor, and on the basis of the battery temperature detected by the battery temperature sensor.

The inverter 200 is connected to the ECU 100. The inverter 200 is provided with intelligent power modules (IPMs) for controlling the motor generators MG1 and MG2 respectively. The IPMs are each made up of a plurality of (for instance, six) semiconductor switching elements (for instance, insulated gate bipolar transistors (IGBTs)) or the like.

The inverter 200, for instance, converts DC current from the battery 300 to current that drives the motor generators MG1, MG2, in response to a command signal from the ECU 100 (for instance, a torque command value of the first motor generator MG1 or a torque command value of the second motor generator MG2). The inverter 200 also converts AC current that is generated by the first motor generator MG1 driven by the motive power of the engine 1, and AC current that is generated in the second motor generator MG2 as a result of regenerative braking to DC current for charging the battery 300. The inverter 200 supplies the AC current generated in the first motor generator MG1 as electric power for driving of the second motor generator MG2, depending on the travel state.

The hybrid vehicle HV according to the present embodiment travels relying on the second motor generator MG2 alone (hereafter also referred to as “EV travel”), in a case where the operating efficiency of the engine 1 is poor, for instance upon vehicle start or during low-speed travel. The vehicle travels also according to EV travel if the driver selects an EV travel mode via a travel mode selection switch disposed in the cabin.

During ordinary travel, the motive power of the engine 1 is divided for instance into two paths (torque split), by the above-described motive power split mechanism 3, such that in one path (driving based on direct torque) the drive wheels 6L, 6R are directly driven, while in the other path electric power is generated through driving of the first motor generator MG1. The second motor generator MG2 is driven herein by the generated electric power, to afford thereby auxiliary driving of the drive wheels 6L, 6R (driving based on electrical path). Thus, the motive power split mechanism 3 functions as a differential mechanism, such that, through that differential action, the bulk of the motive power from the engine 1 is transmitted mechanically to the drive wheels 6L, 6R. The remaining motive power from the engine 1 is electrically transmitted from the first motor generator MG1 to the second motor generator MG2 via the electrical path; accordingly, the motive power split mechanism 3 functions as a transmission whereby the gear ratio is modified electrically. It becomes possible as a result to operate at free engine revolutions and engine torque, independently from the revolutions and torque of the drive wheels 6L, 6R (ring gears R3, R4). An driving condition of the engine is brought about thus in which the driving force necessary for the drive wheels 6L, 6R is obtained with optimized fuel consumption rate.

During high-speed travel, electric power is supplied from the battery (battery for travel) 300 to the second motor generator MG2, and the output of the second motor generator MG2 is increased, to supplement thereby (driving force assist; powering) the driving force to the drive wheels 6L, 6R.

At low speeds, the second motor generator MG2 functions as a power generator and generates regenerative power. The recovered electric power is stored in the battery 300. When the amount of charge of the battery 300 drops and charging becomes particularly necessary, the output in the engine 1 is increased and the power generation amount by the first motor generator MG1 is increased, to increase thereby the amount of charge in the battery 300. Needless to say, in some instances control is performed to increase the output of the engine 1, as the case may require, also during low-speed travel. Such instances include, for example, cases where the battery 300 must be charged, as described above, or instances of driving of auxiliary equipment, such as air conditioning, or of raising the temperature of cooling water of the engine 1 to a predefined temperature.

In the hybrid vehicle HV, moreover, the engine 1 is stopped, in order to improve fuel economy, if an EV travel condition is determined to be satisfied on the basis of, for instance, the operating condition of the hybrid vehicle HV and the state of the battery 300. The engine 1 is re-started thereafter if the EV travel condition is no longer satisfied. In the hybrid vehicle HV, thus, the engine 1 is in intermitted operation, even if the hybrid system is “On”.

The activation process of the hybrid system in the hybrid vehicle HV will be explained by distinguishing between times at which the vehicle is stopped and times at which the vehicle is traveling. The processes below are executed by the ECU 100 of the hybrid vehicle HV.

With the vehicle stopped, the activation process of the hybrid system is initiated if the power switch 8 is operated (for instance, through short pressing), with the brake pedal in a depressed state. A system check set beforehand is executed first. Once the system check is over, a system main relay (not shown) is connected.

The system main relay is a relay for connecting or disconnecting the battery 300 and the inverter 200 to/from each other. Through connection of the system main relay, it becomes possible to drive the motor generators MG1, MG2 by electric power that is supplied from the battery 300, and to charge the battery with electric power that is generated by the motor generators MG1, MG2.

The engine 1 can be started when the EV travel condition is not satisfied, for instance if the engine is cold or the SOC of the battery 300 is low. Startup of the engine 1 is accomplished by the first motor generator MG1 that is driven by electric power from the battery 300. Thereafter, when the vehicle is in a Ready-On state (travel-enabled state), an indicator lamp that indicates that state is lit in the instrument cluster (not shown).

When, for instance, warm-up of the engine 1 is not necessary, or the battery 300 need not be charged, i.e. if the EV travel condition is satisfied, the vehicle is placed in the Ready-On state, without start of the engine 1, and an indicator lamp that indicates that state is lit in the instrument cluster.

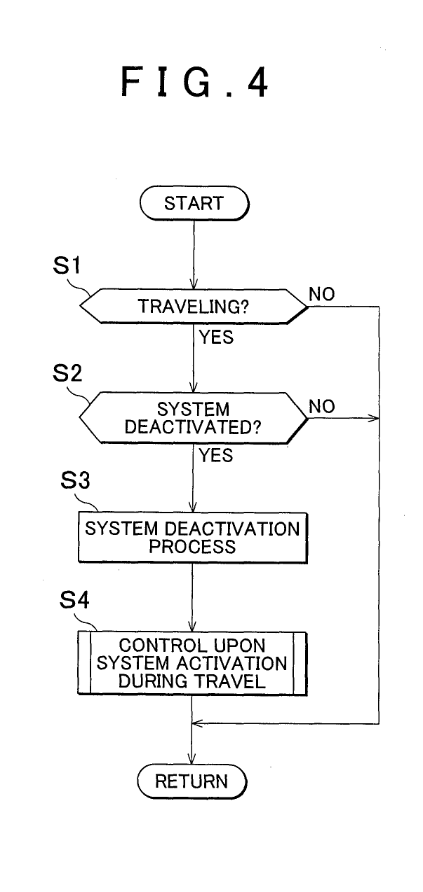

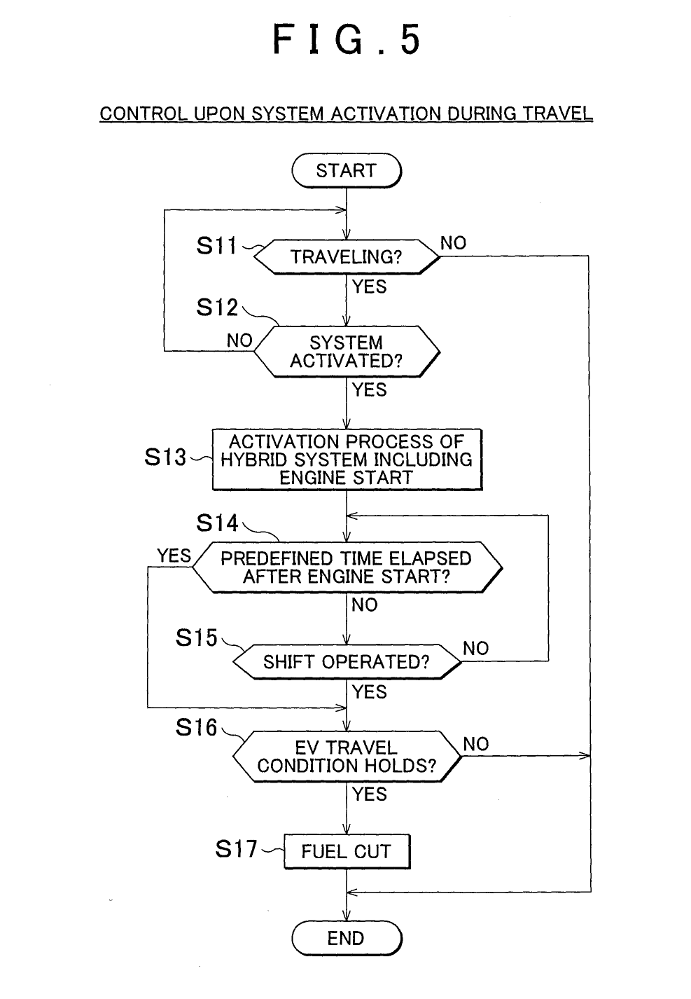

FIG. 4 and FIG. 5 are flowcharts for explaining the activation process of the hybrid system during travel of the hybrid vehicle. An activation process of the hybrid system during travel of the hybrid vehicle HV will be explained with reference to FIG. 4 and FIG. 5. In the hybrid vehicle HV, the hybrid system must be activated in order to initiate travel. The hybrid system is active in ordinary travel, and hence the explanation below will deal with a series of process flows from deactivation to re-activation of the hybrid system during travel.

Firstly, in step S1 of FIG. 4, the ECU 100 determines whether or not the vehicle is traveling. For instance, the ECU 100 determines whether or not the vehicle is traveling on the basis of a signal outputted by the wheel speed sensor 105. Herein, travel may denote any one from among EV travel, travel only by motive power from the engine 1, or travel in which the motive power from the engine 1 is assisted by the second motor generator MG2. If the ECU 100 determines that the vehicle is traveling, the process proceeds to step S2. On the other hand, if the ECU 100 determines that the vehicle is not traveling, the process returns.

Next, in step S2, the ECU 100 determines whether the hybrid system has been deactivated or not (for instance, pressing and holding of the power switch 8). Specifically, the ECU 100 determines whether or not a deactivation operation has taken place on the basis of a signal outputted by the power switch 8. If the ECU 100 determines that the hybrid system has been deactivated, the process proceeds to step S3. If, on the other hand, the ECU 100 determines that the hybrid system has not been deactivated, the process returns.

Next, in step S3, The ECU 100 initiates the deactivation process of the hybrid system. The deactivation process of the hybrid system includes, for instance, stop of the engine 1 by fuel cut-off when the engine 1 had been driven, discontinuation of the driving of the motor generators MG1, MG2 through gate shutoff of the inverter 200, or shutoff of the system main relay. The indicator lamp that indicates the Ready-On state may be turned off when the deactivation process of the hybrid system is initiated.

Next, in step S4, the ECU 100 performs control upon system activation during travel of the vehicle. The process returns after the control upon system activation during travel is over (end).

In step S11, in FIG. 5, of the control upon system activation during travel of the vehicle, firstly, the ECU 100 determines whether or not the vehicle is traveling. If the ECU 100 determines that the vehicle is traveling, the process proceeds to step S12. It on the other hand, the ECU 100 determines that the vehicle is not traveling, coasting of the vehicle is discontinued, and the process moves on to the end thereof, without system activation during travel of the vehicle.

Next, in step S12, the ECU 100 determines whether the activation operation of the hybrid system has been performed or not (for instance, short pressing of the power switch 8). Specifically, the ECU 100 determines whether the activation operation of the hybrid system has been performed or not on the basis of a signal outputted by the power switch 8. If the ECU 100 determines that the activation operation of the hybrid system has been performed, the process proceeds to step S13. If, on the other hand, the ECU 100 determines that the activation operation of the hybrid system has not been performed, the process returns to step S11.

Next, in step S13, the ECU 100 performs an activation process of the hybrid system that includes start of the engine 1. The activation process of the hybrid system includes, for instance, system check, connection of the system main relay, start of the engine 1 and so forth. Specifically, if the hybrid system is activated during travel of the hybrid vehicle HV, the engine 1 starts, regardless of whether the EV travel condition is satisfied or not. The activation process is terminated and the vehicle is placed in a Ready-On state, and the indicator lamp that indicates that state in the instrument cluster lights up.

Startup of the engine 1 is performed for the purpose of notifying to the occupant, such as the driver, that the activation operation has been received. Accordingly, there is a chance that drivability may decrease when the motive power of the engine 1 is outputted to the drive shafts 61. During start of the engine 1, therefore, the motor generators MG1, MG2 are controlled coordinately in such a way so as to suppress output of the motive power of the engine 1 to the drive shafts 61. Upon start of the engine 1 in step S13, control is performed in such a manner that the proportion of the motive power that is outputted from the engine 1 to the drive shafts 61 is smaller than upon start of the engine 1 in normal times. Herein, normal times denote cases where, for instance, the EV travel condition during EV travel is not satisfied and the engine 1 is started.

A first value of a start parameter used in a start processing by the ECU 100 of the engine 1 differs from a second value of the start parameter upon start of the engine 1 at normal times. Specifically, the start parameter is set to be the first value in such a manner that the rotational speed of the engine 1 is greater than in the case where the second start parameter is to the second value. The first and the second values differ from each other. The start parameter includes, for instance, intake air amount, fuel injection amount, ignition timing and the like. The start parameter is a parameter that affects the start condition of the engine. A start mode of the engine varies in accordance with the value of the start parameter. The start parameter may be corrected in accordance with the depression amount or depression speed of the accelerator pedal when the accelerator is depressed. Increased rotational speed includes instances where the absolute value of the rotational speed increases and instances where the change of rate of the rotational speed increases.

Next, in step S14, the ECU 100 determines whether or not a predefined time has elapsed after start of the engine 1. Herein, the predefined time denotes a time set beforehand, for instance 10 seconds. If the ECU 100 determines that a predefined time has not elapsed, the process proceeds to step S15. On the other hand, if the ECU 100 determines that a predefined time has elapsed, the process proceeds to step S16.

Next, in step S15, the ECU 100 determines whether or not the shift lever 71 (FIG. 2) has been operated. Operations of the shift lever 71 include, for instance, setting the shift lever 71 from the N position to the D position. The ECU 100 determines whether or not the shift lever 71 has been operated on the basis of a signal outputted by the shift position sensor 104. If the ECU 100 determines that the shift lever 71 has not been operated, the process proceeds to step S14. On the other hand, if the ECU 100 determines that the shift lever 71 has been operated, the process proceeds to step S16.

Next, in step S16, the ECU 100 determines whether the EV travel condition is satisfied or not, on the basis of, for instance, the operating condition of the hybrid vehicle HV and the state of the battery 300. If the ECU 100 determines that the EV travel condition is satisfied, the process proceeds to step S17. If, on the other hand, the ECU 100 determines that the EV travel condition is not satisfied, driving of the engine 1 is continued, and the process moves on to the end thereof.

Next, in step S17, the ECU 100 cuts fuel off, discontinues driving of the engine 1, and the process moves on to the end thereof, in a state of EV travel.

In the present embodiment, as described above, the hybrid system is deactivated as a result of a deactivation operation of the hybrid system during travel of the vehicle. When, thereafter, the activation operation of the hybrid system is performed before the hybrid vehicle HV is stopped, the engine 1 is started even if EV travel is enabled. In such a configuration, sound and vibration occur through start of the engine 1. Accordingly, the driver can be readily made aware of the fact that the activation operation has been received. As a result, it becomes possible to impart a sense of reassurance to a driver who might be unable to check the indicator that indicates the Ready-On state, or who may be concerned about a malfunction of the engine 1.

In the present embodiment, the first value set as the start parameter and the second value set as the start parameter are different from each other. Accordingly, sound and vibration can be generated that are appropriate for making the driver aware of the reception of the activation operation.

In the present embodiment, the start parameter is set to be the first value in such a manner that the rotational speed of the engine 1 is greater than in the case where the start parameter is set to be the second value. As a result, sound and vibration upon start of the engine 1 can be made more intense. Accordingly, the driver can be easily made aware of the reception of the activation operation.

In the present embodiment, the motor generators MG1, MG2 are controlled coordinately in such a way so as not to transmit output of the motive power of the engine 1 to the drive shafts 61 during start of the engine 1, in step S13. As a result, it becomes possible to suppress drops in drivability derived from startup of the engine 1.

In the present embodiment, when a predefined time elapses after start of the engine 1 (step S14: Yes), driving of the engine 1 is discontinued if the EV travel condition is satisfied (step S16: Yes). As a result, consumption of fuel in the engine 1 can be reduced while preventing the driver from mistakenly concluding that the engine is in a stall state. Drops in fuel economy can be thus suppressed.

When in the present embodiment the shift lever 71 is operated (step S15: Yes), driving of the engine 1 is discontinued if the EV travel condition is satisfied (step S16: Yes). As a result, it becomes possible to avoid useless consumption of fuel in the engine 1 after the driver has recognized that the activation operation has been received.

All the features of the embodiment disclosed herein are exemplary in character, and constitute in no way a basis for narrow interpretation. The technical scope of the invention, therefore, is not to be interpreted in the light of the above-described embodiment alone, but is defined according to the disclosure of the claims. The technical scope of the invention encompasses all modifications within the scope of the appended claims and equivalents thereof.

In the present embodiment, for instance, an example has been explained wherein the invention is used in a FF-type hybrid vehicle HV. However, the invention is not limited thereto, and may be used in a hybrid vehicle of FR type or 4WD type.

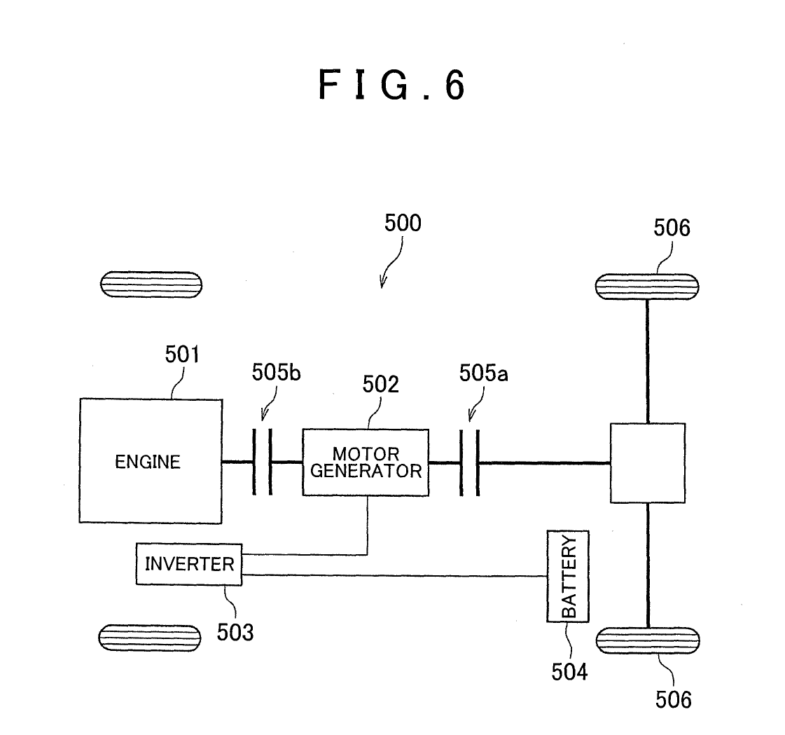

For instance, the invention may be used in a hybrid vehicle 500 of FR type, as in the variation illustrated in FIG. 6. The hybrid vehicle 500 is provided with an engine 501, a motor generator 502 that functions as a motor and as a power generator, an inverter 503 that drives the motor generator 502, and a battery 504 that supplies electric power that drives the motor generator 502 and that stores electric power generated by the motor generator 502. In the hybrid vehicle 500, it is possible for the motor generator 502 alone to drive the rear wheels 506 through connection of a clutch 505a and disconnection of a clutch 505b. Connection between the clutches 505a and 505b enables the engine 501 to drive the rear wheels 506, and the motor generator 502 to be charged or to generate assist torque. In the hybrid vehicle 500, moreover, the motive power of the engine 501 need not be outputted to the rear wheels 506 through disconnection of the clutch 505h when the engine 501 is started in step S13.

The present embodiment illustrates an example where the invention is used in a so-called split-type hybrid vehicle HV that is provided with two motor generators MG1, MG2 and a motive power split mechanism 3. However, the invention is not limited thereto, and the invention may be used in a series or parallel hybrid vehicle. In a series hybrid vehicle, the engine is used only for power generation by way of a power generator, and drive wheels are driven by a motor alone. In a parallel hybrid vehicle, the drive wheels are driven by an engine and a motor.

In the present embodiment an example has been illustrated wherein the hybrid vehicle HV is provided with two motor generators MG1, MG2. However, the present embodiment is not limited thereto, and one or three or more motor generators may be provided in the hybrid vehicle. For instance, the hybrid vehicle HV of the invention may be further provided with a third motor generator that drives a rear axle, in addition to the first motor generator MG1 and the second motor generator MG2.

In the present embodiment, an example of the operation unit of the invention has been explained in the form of the power switch 8 that is a rebound-type push switch. However, the invention is not limited thereto, and the operation unit of the invention may be embodied in any way, so long as it can receive an operation. For instance, the operation unit of the invention may be a lever switch, a slide switch, or a key switch that rotates through insertion of a key in a cylinder.

In the present embodiment, the activation operation of the hybrid system may be performed in step S12 after total completion of the deactivation process of the hybrid system initiated in step S3, i.e. in a state where the hybrid system is completely deactivated. The activation operations of the hybrid system may be performed in step S12 before total completion of the deactivation process of the hybrid system initiated in step S3, i.e. in a state where only part of the hybrid system is deactivated, and the rest remains in an activated state.

In step S13 of the present embodiment, part of the activation process may be left unexecuted when an activation process of the hybrid system that includes start of the engine 1 is performed. For instance, start of the engine 1 may be set so as to be avoided in cases of, for instance, malfunction of the engine 1, or trouble in the hybrid vehicle HV caused by start of the engine 1.

An example has been illustrated wherein the engine 1 is started at the time of the activation process of the hybrid system in step S13 of the present embodiment. However, the invention is not limited thereto, and the engine 1 may be set to be started only in such instances where start of the engine 1 is necessary for component protection, or instances where start of the engine 1 is necessary for heating, at the time of the activation process of the hybrid system.

In the present embodiment, an example has been illustrated wherein the start parameter is set to be the first value in such a manner that the rotational speed of the engine 1 is greater than in the case where the start parameter is set to be the second value. However, the invention is not limited thereto, and the start parameter may be set to be the first value in such a manner that the motive power of the engine 1 is smaller than in the case where the start parameter is set to be the second value. As a result, it becomes possible to suppress drops in drivability derived from startup of the engine 1.

In the present embodiment, long-pressing of the power switch 8 has been illustrated as an example of a deactivation operation of the hybrid system during travel of the vehicle. However, the invention is not limited thereto, and the deactivation operation of the hybrid system may involve short pressing of the power switch 8 over a plurality of times. The deactivation operation of the hybrid system may be identical during stopping and during travel of the hybrid vehicle HV.

In the present embodiment, a buck-boost converter may be provided between the inverter 200 and the battery 300.

An example has been illustrated wherein the engine 1 is started regardless of whether the EV travel condition is satisfied or not, in step S13 of the present embodiment. However, the invention is not limited thereto, and the EV travel condition may include a condition of “non-activation during travel of vehicle”. Accordingly, the process may be set so that it is determined whether the EV travel condition is satisfied or not and then the EV travel condition is not satisfied, in step S13.

An example has been explained wherein in step S14 of the present embodiment it is determined whether or not a predefined time has elapsed since start of the engine 1. However, the invention is not limited thereto, and there may be determined whether or not a predefined time has elapsed after the hybrid system has been activated.

In the present embodiment, the predefined time may be a fixed value, or may be a varying value. For instance, the predefined time may vary as a result of a calculation on the basis of various parameters.

In the present embodiment, the engine 1 may be set to stop only when a predefined operation of the shift lever 71 has been carried out (for instance, setting from the N position to the D position); alternatively, the engine 1 may be set to stop also in case where any operation of the shift lever 71 is carried out.

In the present embodiment, an example has been explained wherein the engine 1 is stopped (step S17) if the EV travel condition is satisfied (step S16: Yes). However, the invention is not particularly limited thereto, and the engine 1 may be set to be stopped when a predefined time has elapsed after start of the engine 1, or after a shift operation has been carried out. That is, step S16 of FIG. 5 may be omitted.

In the present embodiment, the hybrid system is configured to be activated when the power switch 8 is operated, if the vehicle is traveling, even if the brake pedal is not depressed. However, the invention is not limited thereto, and the hybrid system may be configured to be activated, through operation of the power switch 8, only when the brake pedal is depressed, also during travel of the vehicle. Also, the hybrid vehicle HV may be brought to a state (so-called Accessory-On) such that, for instance, only auxiliary equipment can be driven when the power switch 8 is operated in a state where the brake pedal is not depressed while the hybrid vehicle HV is stopped.

In the present embodiment, an example has been explained wherein the engine is started upon re-activation of the hybrid system during travel of the vehicle. However, the invention is not limited thereto, and if the hybrid system is deactivated during travel of the vehicle, then the engine may be started upon re-activation of the hybrid system, even if the vehicle is stopped after deactivation operation of the hybrid system is performed.

While the disclosure has been explained in conjunction with specific exemplary embodiments thereof, it is evident that many alternatives, modifications, and variations will be apparent to those skilled in the art. Accordingly, exemplary embodiments of the disclosure as set forth herein are intended to be illustrative, not limiting. There are changes that may be made without departing from the scope of the disclosure.

1-11. (canceled)

12. A control device of a vehicle, comprising:
an engine;
an electric motor configured to drive the vehicle in a state where the engine is stopped;
an operation unit configured to receive operations to activate and deactivate a vehicle system that controls travel of the vehicle; and
a controller configured to determine whether or not the vehicle is traveling and so that, during travel of the vehicle, when the operation unit receives the operation to deactivate the vehicle system, and then the operation unit receives the operation to activate the vehicle system when the vehicle is traveling and before the vehicle stops, the controller starts the engine.

13. The control device according to claim 12, wherein
the controller is configured so that, during travel of the vehicle, when the operation unit receives the operation to deactivate the vehicle system, and then the operation unit receives the operation to activate the vehicle system after at least part of the vehicle system has been deactivated and before the vehicle stops, the controller starts the engine.

14. The control device according to claim 13, wherein
the at least part of the vehicle system includes supply of fuel to the engine.

15. The control device according to claim 12, wherein
the controller is configured so that, when the operation unit receives the operation to activate the vehicle system before the vehicle stops, the controller sets a start parameter used to start the engine to be a first value which differs from a second value of the start parameter used to start the engine at normal times, and a start mode of the engine varies in accordance with the value of the start parameter.

16. The control device according to claim 15, wherein
the controller sets the start parameter to be the first value in such a manner that a rotational speed of the engine is greater than in the case where the start parameter is set to the second value.

17. The control device according to claim 15, wherein
the controller sets the start parameter to be the first value in such a manner that motive power of the engine is smaller than in the case where the start parameter is set to the second value.

18. The control device according to claim 12, wherein
the vehicle is configured to control a proportion of motive power generated by the engine and motive power generated by the electric motor, out of motive power that is outputted to drive wheels; and
the controller sets the proportion of motive power that is transmitted from the engine to the drive wheels to be smaller in a case where the engine is started when the operations unit receives the operation to activate the vehicle system during travel of the vehicle, than in a case where the engine is started at normal times.

19. The control device according to claim 12, wherein
the controller is configured to discontinue supply of fuel to the engine, when the operation unit receives the operation to activate the vehicle system so as to start the engine before the vehicle stops and then a predetermined period of time elapses after the engine starts.

20. The control device according to claim 12, wherein
the controller is configured to discontinue supply of fuel to the engine, when the operation unit receives the operation to activate the vehicle system so as to start the engine before the vehicle stops and then a shift operation is performed after the engine starts.

21. The control device of a vehicle, comprising:
an engine;
an electric motor configured to drive the vehicle in a state where the engine is stopped;
an operation unit configured to receive operations to activate and deactivate a vehicle system that controls travel of the vehicle; and
a controller configured to determine whether or not the vehicle is traveling and so that, during travel of the vehicle, when an occupant performs the operation to deactivate the vehicle system through the operation unit, and then the occupant performs the operation to activate the vehicle system through the operation unit when the vehicle is traveling and before the vehicle stops, the controller starts the engine.

22. A control device of a vehicle, comprising:
an engine;
an electric motor configured to drive the vehicle in a state where the engine is stopped;
an operation unit configured to receive operations to activate and deactivate a vehicle system that controls travel of the vehicle; and
a controller configured to determine whether or not the vehicle is traveling and so that, during travel of the vehicle, when the controller receives a signal to deactivate the vehicle system from the operation unit and then the controller receives a signal to activate the vehicle system from the operation unit when the vehicle is traveling and before the vehicle stops, the controller starts the engine.
